(19) United States
(12) Patent Application Publication
(10) Pub. No.: US 2004/0148867 A1
(43) Pub. Date: Aug. 5, 2004

(54) Metal abrasive composition and polishing method

(75) Inventor: Yasuo Matsumi, Tsukuba-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/701,664

(22) Filed: Nov. 6, 2003

(30) Foreign Application Priority Data
Nov. 8, 2002 (JP) 2002-324987

(51) Int. Cl. B44C 1/22

(52) U.S. Cl. 51/298; 51/308; 51/307; 216/89; 438/692; 438/693

(57) ABSTRACT

There is provided a metal abrasive composition which can polish metal wiring at high speed and control the etching rate thereof in manufacturing a semiconductor device. A metal abrasive composition comprises (a) a chelating resin particle having at least one functional group selected from the group consisting of an aminocarboxylic acid group, an aminophosphonic acid group and an iminodiacetic acid group, (b) an inorganic particle, and (c) a surfactant having at least one functional group selected from a group consisting of a carboxylic acid group, a sulfonic acid group and a phosphoric acid group.

### FIELD OF THE INVENTION

The present invention relates to a metal abrasive composition.

### BACKGROUND OF THE INVENTION

In recent years, various techniques for fine processing have been attracting the attention for realizing high degree of integration and high performance of LSI. Among these, a chemical mechanical polishing (sometimes abbreviated hereinafter as CMP) is a technique so as to utilize both chemical actions and mechanical actions between an abrasive composition and a polished body, and particularly is a essential technique of planarizing inter insulation layers, forming metal plugs, forming buried metal wiring, and the like in a process of forming multilayer wiring.

To forming buried wiring with using a metal having a low resistance has been actively studied from the viewpoint of realizing high speed of LSI, and simultaneously an abrasive composition for polishing a metal having a low resistance has been studied.

In order to improve the polishing rate, therefore, a technology for high speed polishing with simultaneous etching have been developed by adding an additive with etching nature such as a complexing agent (for example, amine, glycine or the like) capable of forming a water-soluble metal complex by reacting with a metal ion. However in the case of polishing metal wiring formed on a semiconductor substrate, with using such abrasive composition the dishing such that the etching rate of metal wiring is increased and the central thickness of metal wiring is thinned is occurred, resulting in a deterioration of the planarity and an increase in resistance value.

Accordingly, an abrasive composition comprising a chelating resin particle such as ion exchange substance, an in organic particle, and water has been studied (JP No.2001-311073 and JP No.2002-261052 A); however, it is still necessary to improve in the control of-the etching rate of metal wiring.

The object of the present invention is to provide a metal abrasive composition which can polish metal wiring at high speed and control the etching rate thereof in manufacturing a semiconductor device.

### SUMMARY OF THE INVENTION

Through earnest studies for finding out a metal abrasive composition which is capable of solving the problem as described above, the inventors of the present invention have completed the present invention by finding out that a metal abrasive composition comprising an inorganic particle, a chelating resin particle having at least one functional group selected from the group consisting of an aminocarboxylic acid group, an aminophosphonic acid group and an iminodiacetic acid group, and a surfactant having at least one functional group selected from the group consisting of a carboxylic acid group, a sulfonic acid group and a phosphoric acid group can polish metal wiring at high speed and sufficiently control the etching rate thereof in manufacturing a semiconductor device.

### SUMMARY OF THE INVENTION

The present invention provides a metal abrasive composition comprising (a) a chelating resin particle having at least one functional group selected from the group consisting of an aminocarboxylic acid group, an aminophosphonic acid group and an iminodiacetic acid group, (b) an inorganic particle, and (c) a surfactant having at least one functional group selected from the group consisting of a carboxylic acid group, a sulfonic acid group and a phosphoric acid group.

### DETAILED DESCRIPTION OF PREFERRED EMBODIMENTS

A metal abrasive composition of the present invention comprises an inorganic particle, a chelating resin particle having at least one functional group selected from the group consisting of an aminocarboxylic acid group, an aminophosphonic acid group and an iminodiacetic acid group, and a surfactant having at least one functional group selected from the group consisting of a carboxylic acid group, a sulfonic acid group and a phosphoric acid group.

The examples of an aminocarboxylic acid group, an aminophosphonic acid group and an iminodiacetic acid group include, for example, following groups.

An example of aminocarboxylic acid group includes a group represented by the formula (1).

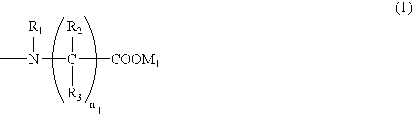

wherein, R₁, R₂ and R₃ independently represent hydrogen atom, hydrocarbon group having 1 to 5 carbon atoms, n₁ represents an integer of from 1 to 5, and M₁ represents an counter ion.

Examples of hydrocarbon group having 1 to 5 carbon atoms include, for example, methyl group, ethyl group, propyl group, isopropyl group, butyl group, isobutyl group, sec-butyl group, tert-butyl group, pentyl group, neopentyl group, tert-pentyl group. Preferable R₁, R₂ and R₃ are hydrogen atoms. n₁ is preferably an integer of from 1 to 3, more preferably 1.

An example of aminophosphonic acid group includes a group represented by the formula (2).

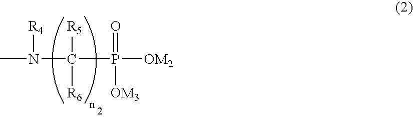

wherein, R₄, R₅ and R₆ independently represent hydrogen atom, hydrocarbon group having 1 to 5 carbon atoms, n₂ represents an integer of from 1 to 5, and M₂ and M₃ represent counter ions and these are same or different from each other.

Examples of hydrocarbon group having 1 to 5 carbon atoms include the same groups as described above. Preferable R₄, R₅ and R₆ are hydrogen atoms. n₂ is preferably an integer of from 1 to 3, more preferably 1.

The example of an iminodiacetic acid group include a group represented by formula (3).

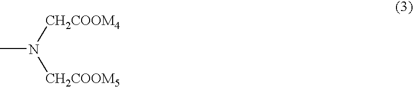

wherein, M4 and M5 are counter ions and these are same or different from each other.

Among functional groups of a chelating resin particle of the present invention, an iminodiacetic acid group is preferable from the viewpoint of polishing metal wiring at high speed.

An Na type of chelating resin particle such that a counter ion of a functional group thereof is a sodium ion is generally used for a chelating resin particle having these functional groups, and in the case of being applied to a process of manufacturing a semiconductor, a hydrogen ion (H type) or an ammonium ion (ammonium type) represented in the following general formula as a counter ion is preferably used as a counter ion from the viewpoint of less affecting as semiconductor device.

⁺NR₇R₈R₉R₁₀ (4)

In the formula, R₇, R₈, R₉ and R₁₀ denote each independently a hydrogen atom, or a hydrocarbon group with a carbon number of 1 to 5 or a benzyl group.

Examples of hydrocarbon group having 1 to 5 carbon atoms include the same groups as described above. R₇, R₈, R₉ and R₁₀ are preferably a hydrogen atom or an alkyl group with a carbon number of 1 to 5, more preferably a hydrogen atom.

A chelating resin particle having an aminocarboxylic acid group, an aminophosphonic acid group and an iminodiacetic acid group as a functional group can be produced by a known method; for example, including a method of polymerizing a monomer having an intended functional group, a method of chemically converting into an intended functional group a functional group which is contained in a polymerized polymer particle.

Examples of a monomer for the chelating resin include, for example, vinyl aromatic compounds such as styrene and α-methylstyrene, unsaturated carboxylic compounds such as acrylic acid and methacrylic acid, acrylic acid esters such as methyl acrylate and ethyl acrylate, methacrylic acid esters such as methyl mthacrylate and ethyl methacrylate, olefin such as ethylene and propylene, halogenated olefin such as vinyl chloride. Among above, vinyl aromatic compounds, unsaturated carboxylic compounds, acrylic acid esters, methacrylic acid esters are preferable.

An example of a chelating resin includes a polymer of the above monomer and copolymer of two or more of the above monomer. When a copolymer is used for a chelating resin, a cross linked copolymer of two or more monomers of the above monomers is preferable. A cross linked copolymer is usually obtained by co-polymerization of the above monomer and a cross linking agent. An example of cross linking agent includes divinyl benzene and ethyleneglycol dimethacrylate.

A preferable example of copolymer include, for example, copolymer of styrene and the cross linking agent, copolymer of (meth)acrylatic acid and the cross linking agent, and (meth)acrylate and the cross linking agent.

A known method can be applied also to a method of making a counter ion of a functional group into at least one selected from a group consisting of an H type and an ammonium type represented in the above-mentioned general formula; for example, including a method of converting a counter ion of a functional group of a monomer into an intended counter ion, a method of converting another counter ion into an intended counter ion by the ion exchange method. With regard to the ion exchange method, for example, a chelating resin particle in which a counter ion is an Na type is filled into a column, and hydrochloric acid solution is flown through the column so as to convert a counter ion into an H type and further into an ammonium type by flowing an amine aqueous solution through the column. In the ion exchange method, the batch treatment by stirring can be also performed in addition to a method of flowing with the use of a column.

A functional group of a chelating resin particle preferably exists on the particle surface of a resin; however even in the case where a functional group does not exist thereon, such as a functional group exists inside of the particle or the particle is covered by coating film, a resin such as its particle can be easily crushed or the coating film covering its particle is easily peeled off, by an external force like stress acting during polishing is preferably used, since a functional group for acquiring metal is exposed to the surface so as to possibly contact with metal to be polished, and then brings the same effect to a chelating resin particle.

A chelating resin particle is preferably a particle having an average particle diameter of 1.0 μm or less from the viewpoint of processing accuracy on a polished surface. An excellent processed surface may not be obtained by using an average particle diameter of more than 1.0 μm.

In the present invention, the average particle diameter is an average particle diameter (an average secondary particle diameter) measured by the dynamic light scattering method.

A chelating resin particle having an average particle diameter of 1.0 μm or less can be obtained by a method of wet-grinding a chelating resin having an aminocarboxylic acid, an aminophosphonic acid and an iminodiacetic acid as a functional group, and the like.

The method of wet-grinding includes a method by using a known grinding apparatus such as a vibrating mill, a ball mill, a nanomizer and an ultimaizer. Zirconia and polymer are preferably used in a part contacting with liquid in order to avoid metal contamination from a grinding apparatus. If necessary, a coarse particle may be classified and sized into a desirable grading by performing a process such as wet gravitational sedimentation, centrifugal sedimentation and filtering.

Also, the treating of primary crush by dry-grinding before wet-grinding is preferable for raising the efficiency in grinding in wet-grinding. The method of dry-grinding includes a method by using a grinding device such as a jaw crusher, a gyratory crusher, a roll crusher, an edge runner, a hammer crusher, a ball mill, a jet mill and a disk crusher. Zirconia and polymer are preferably used in a part contacting with liquid in order to avoid metal contamination from a grinding device and the like. If necessary, a coarse particle may be classified and sized into a desirable grading by using a device such as dry wind force classification.

A counter ion of a functional group of a chelating resin to be treated by wet-grinding is preferably at least one kind selected from the group consisting of an H type and an ammonium type represented in the above-mentioned general formula, and in the case of not being an H type nor an ammonium type, a counter ion may be made into an H type or an ammonium type by the ion exchange after being treated by wet-grinding. For example, after wet-grinding an Na type chelating resin, a proton acid such as hydrochloric acid and nitric acid is added thereto so as to separate a sodium ion and remove the sodium ion by filtration such as film filtration, obtaining an H type. The obtained H type can be further made into an ammonium type by adding amine thereto.

A chelating resin particle in a metal abrasive composition of the present invention preferably has a concentration of 0.1 to 30 weight %. When a concentration of a chelating resin particle is less than 0.1 weight %, a sufficient polishing rate may not be obtained, while a concentration of a chelating resin particle is more than 30 weight %, an improvement in the polishing rate proportionate to the concentration may not be recognized.

An inorganic particle used in the present invention includes an inorganic particle comprising a metal oxide such as silica, alumina, aluminosiliqate, cerium oxide, manganese dioxide and zirconia. These inorganic particles may be used alone or in a combination of two or more kinds thereof.

Among these inorganic particles, a silica particle is preferable from the viewpoint that the hardness thereof is lower than that of other inorganic particles so that the silica particles hardly scratch on metal wiring, and from the viewpoint that the specific gravity thereof is close to that of water so that the silica particles hardly precipitate. Colloidal silica is more preferable from the viewpoint that the costs thereof are inexpensive and the shape of a particle thereof is close to a sphere so as to hardly scratch.

When the average particle diameter of a chelating resin particle is denoted as A and the average particle diameter of an inorganic particle is denoted as B, the ratio (A/B) between the average particle diameters is preferably 3 or more, more preferably 15 or more. If the ratio (A/B) between the average particle diameters is less than 3, the etching rate of metal wiring may not be controlled. The ratio is preferably not more than 60.

An inorganic particle in a metal abrasive composition of the present invention preferably has a concentration of 0.01 to 10 weight %. When a concentration of an inorganic particle is less than 0.01 weight %, a sufficient polishing rate may not be obtained, while a concentration of an inorganic particle is more than 10 weight %, an excellently processed surface may not be obtained.

A chelating resin particle in a metal abrasive composition of the present invention preferably has zeta potential with the same sign as that of zeta potential of an inorganic particle, and more preferably both of them have zeta potential with the negative sign. When zeta potential of a chelating resin particle has a different sign from that of zeta potential of an inorganic particle, an abrasive composition comprising such chelating resin particle and in organic particle may not have a sufficient polishing rate.

A surfactant used in the present invention is a surfactant having at least one functional group selected from the group consisting of a carboxylic acid group, a sulfonic acid group and a phosphoric acid group. The surfactant having the functional group includes an anionic surfactant and an ampholytic surfactant, which may be used alone or in a combination of two or more kinds thereof.

Examples of the anionic surfactant include, for example, surfactants with a group having a structure represented by the following formula.

Phosphates, ether phosphates or a salt thereof represented by formula (6) to (7);

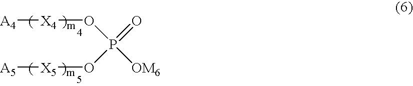

wherein, A₄ and A₅ independently represent hydrocarbon groups having 8 to 32 carbon atoms, X₄ and X₅ independently represent CH₂CH₂O (oxyethylene), CH₂CH₂CH₂O (oxypropylene) and CH₂CH₂OCH₂CH₂CH₂O (oxyethylene oxypropylerne), and m₄ and m₅ independently represent a positive number of from 0 to 100. M₆ represents counter ion.

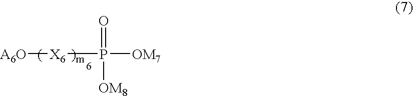

wherein, A₆ represents a hydrocarbon group having 8 to 32 carbon atoms, X₆ represents CH₂CH₂O (oxyethylene), CH₂CH₂CH₂O (oxypropylene) and CH₂CH₂OCH₂CH₂CH₂O (oxyethylene oxypropylerne), and m₆ represents a positive number of from 0 to 100. M₇ and M₈ represent counter ion, and these are same or different with each other.

Carboxylic acids or a salt thereof represented by formula (8):

A₇-COOM₉ (8)

wherein, A₇ represents a hydrocarbon group having 8 to 32 carbon atoms, M₉ represents counter ion.

Ether carboxylic acids or a salt thereof represented by formula (9);

A₈O(X₇)CH₂COOM₁₀ (9)

wherein, A₈ represents a hydrocarbon group having 8 to 32 carbon atoms, X₇ represents CH₂CH₂O (oxyethylene), CH₂CH₂CH₂O (oxypropylene) and CH₂CH₂OCH₂CH₂CH₂O (oxyethylene oxypropylerne), and m₇ represents a positive number of from 0 to 100. M₁₀ represents counter ion.

Alkyl sulfonic acids or a salt thereof represented by formula (10);

A₉-SO₃M₁₁ (10)

wherein, A₉ represents a hydrocarbon group having 8 to 32 carbon atoms, M₁₁ represents counter ion.

Sulfates, ether sulfates or a salt thereof represented by formula (11);

A₁₀O(X₈)SO₃M₁₂ (11)

wherein, A₁₀ represents a hydrocarbon group having 8 to 32 carbon atoms, X₈ represents CH₂CH₂O (oxyethylene), CH₂CH₂CH₂O (oxypropylene) and CH₂CH₂OCH₂CH₂CH₂O (oxyethylene oxypropylerne), and m₈ represents a positive number of from 0 to 100. M₁₂ represents counter ion.

Fatty amide ether sulfates and a salt thereof represented by formula (12);

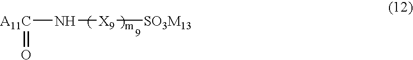

wherein, A₁₁ represents a hydrocarbon group having 8 to 32 carbon atoms, X₉ represents CH₂CH₂O (oxyethylene), CH₂CH₂CH₂O (oxypropylene) and CH₂CH₂OCH₂CH₂CH₂O (oxyethylene oxypropylerne), and m₉ represents a positive number of from 0 to 100. M₁₃ represents counter ion.

Sulfosuccinates and a salt thereof represented by formula (13) and (14);

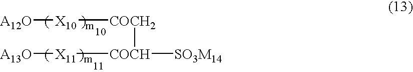

wherein, A₁₂ and A₁₃ independently represent hydrocarbon groups having 8 to 32 carbon atoms, X₁₀ and X₁₁ represents CH₂CH₂O (oxyethylene), CH₂CH₂CH₂O (oxypropylene) and CH₂CH₂OCH₂CH₂CH₂O (oxyethylene oxypropylerne), and m₁₀ and m₁₁ independently represent a positive number of from 0 to 100. M₁₄ represents counter ion.

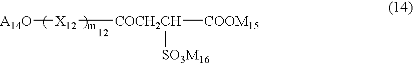

wherein, A₁₄ represents a hydrocarbon group having 8 to 32 carbon atoms, and m₁₂ represents a positive number of from 0 to 100. M₁₅ and M₁₆ represent counter ions and there are the same or different with each other.

Acylated amino acids and a salt thereof represented by formula (15);

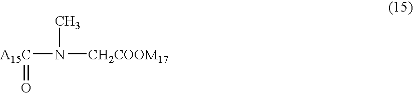

wherein, A₁₅ represents a hydrocarbon group having 8 to 32 carbon atoms and M₁₇ represents counter ion.

Acylated amino sulfonic acids and a salt thereof represented by formula (16);

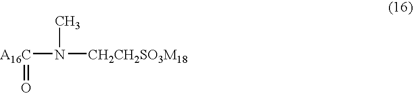

wherein, A₁₆ represents a hydrocarbon group having 8 to 32 carbon atoms and M₁₈ represents counter ion.

Alkyl naphthalene sulfonic acids and a salt thereof represented by formula (17);

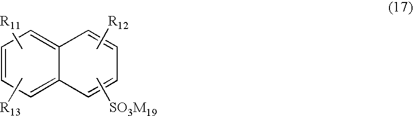

wherein, R₁₁, R₁₂ and R₁₃ independently represent a hydrogen atom, hydrocarbon group having 1 to 5 carbon atoms and M₁₉ represents counter ions.

Sulfonic acids of the condensates of naphthalene and formalin, and a salt thereof represented by formula (18);

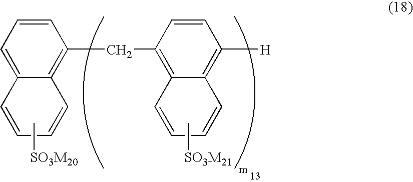

wherein, m₁₃ represents an integer of from 0 to 100. M₂₀ and M₂₁ represent counter ion, and these are same or different with each other.

Alkyl phenyl ether sulfonic acids and a salt thereof represented by formula (19);

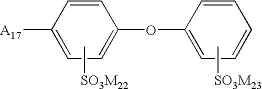

wherein, A₁₇ represents a hydrocarbon group having 8 to 32 carbon atoms and M₂₂ and M₂₃ independently represent counter ion. These are the same or different with each other.

In the above formula, a hydrocarbon group having 8 to 32 carbon atoms may be either a liner or a branched organic group. The Examples include, for example, a saturated alkyl group such as octyl group, decyl group, dodecyl group, hexadecyl group and octadecyl group: an unsaturated alkyl group such as 8,11-heptadecadienyl group and 8,11,14-heptadecatrienyl group: and a group having aromatic ring. An aromatic group includes benzene ring, naphthalene ring and anthracene ring, and these rings may be substituted by alkyl group. Further a group may have one or plural aromatic rings, and when the group has plural aromatic rings, each aromatic ring may be bound directly or through alkylene bond having 1 to 3 carbon atoms, ether bond, carbonyl bond, carboxyl bond or sulfonyl bond.

Among above, a hydrocarbon group having 8 to 24 or a group having one or more aromatic ring is preferable, a hydrocarbon group having 8 to 18 or a group having one or more aromatic ring is more preferable, and a hydrocarbon group having 8 to 18 is most preferable.

In the above formula, n₁, n₂ and n₃ is preferably from 1 to 50, more preferably 2 to 20.

The examples of counter ion include hydrogen ion, alkali metal ion such as sodium ion and potassium ion, alkaline earth metal ion such as magnesium ion and calcium ion, and ammonium ion as represented by formula (21).

⁺NR₁₄R₁₅R₁₆R₁₇ (21)

In the formula, R₁₄, R₁₅, R₁₆ and R₁₇ denote each independently a hydrogen atom, or a hydrocarbon group with a carbon number of 1 to 5 or a benzyl group. An example of the hydrocarbon group with a carbon number of 1 to 5 includes the same as mentioned above. Among them, a hydrogen atom is preferable.

The preferable counter ion is a hydrogen ion or ammonium ion represented by formula (21), and more preferable is a hydrogen ion or ammonium ion represented by formula (21) wherein R₁₄, R₁₅, R₁₆ and R₁₇ are hydrogen atoms.

The examples of phosphates, ether phosphates or a salt thereof represented by formula (6) include, for example, di(poly)oxyethylene lauryl ether phosphoric acid ammonium salt, di(poly)oxyethyleneoxypropylene lauryl ether phosphoric acid ammonium salt, di(poly)oxyethyleneoleyl etherphosphoric acid, di(poly)oxyethyleneoxypropylene lauryl ether phosphoric acid and di(poly)oxypropylene oleyl ether phosphoric acid.

The examples of phosphates, ether phosphates or a salt thereof represented by formula (7) include, for example, lauryl phosphoric acid ammonium salt, octyl ether phosphoric acid ammonium salt, cetyl ether phosphoric acid ammonium salt, polyoxyethylene lauryl ether phosphoric acid, polyoxyethyleneoxypropyl lauryl ether phosphoric acid, polyoxypropylene lauryl ether phosphoric acid, polyoxyethylene tristyrylphenyl ether phosphoric acid triethanol amine, polyoxyethyleneoxypropylene tristyrylphenyl ether phosphoric acid triethanol amine and polyoxypropylene tristyrylphenyl ether phosphoric acid triethanol amine.

The example of carboxylic acids or a salt thereof represented by formula (8) include, for example, potassium lauryl acid salt and potassium myristic acid.

The example of ether carboxylic acids or a salt thereof represented by formula (9) include, for example, (poly)oxyethylene lauryl ether acetic acid, (poly)oxyethyleneoxypropylene lauryl ether acetic acid, (poly)oxypropylene lauryl ether acetic acid and (poly)oxyethylene tridecyl ether acetic acid.

The example of alkyl sulfonic acids or a salt thereof represented by formula (10) include, for example, sodium tetradecene sulfonic acid and dodecylbenzene sulfonic acid ammonium salt.

The sulfates, ether sulfates or a salt thereof represented by formula (11) include, for example, lauryl ammonium sulfate, polyoxyethylene lauryl ether ammonium sulfate, polyoxyethyleneoxypropylene lauryl ether ammonium sulfate, polyoxypropylene lauryl ether ammonium sulfate, polyoxyethylene nonylphenyl ether ammonium sulfate, polyoxyethylene tristyrylphenyl ether ammonium sulfate, polyoxyethyleneoxypropylene tristyrylphenyl ether ammonium sulfate and polyoxypropylene tristyrylphenyl ether ammonium sulfate.

The example of fatty amide ether sulfates and a salt thereof represented by formula (12) include, for example, polyoxyethylene coconut oil fatty acid monoethanolamide ammonium sulfate and polyoxypropylene coconut oil fatty acidmonoethanolamide ammonium sulfate.

The example of sulfosuccinates and a salt thereof represented by formula (13) include, for example, dioctyl sulfosyccinate polyoxyethylene sulfosuccinate lauryl diammonium, dioctyl sulfosyccinate polyoxyethyleneoxypropylene sulfosuccinate lauryl diammonium and dioctyl sulfosyccinate polyoxypropylene sulfosuccinate lauryl diammonium.

The example of sulfosuccinates and a salt thereof represented by formula (14) include, for example, polyoxyethyleneoxypropylene sulfosuccinate lauryl diammonium and polyoxypropylene sulfosuccinate lauryl diammonium.

The example of acylated amino acids and a salt thereof represented by formula (15) include, for example, coconut oil fatty acid sarcosine triethanol amine, lauryloyl sarcosine ammonium.

The example of acylated amino sulfonic acids and a salt thereof represented by formula (16) include, for example, coconut fatty acid methyltaurin acid ammonium.

The example of alkyl naphthalene sulfonic acids and a salt thereof represented by formula (17) include, for example, mono-isopropyl naphthalene sulfonic acid ammonium, di-isopropyl naphthalene sulfonic acid ammonium and n-butyl naphthalene sulfonic acid.

The sulfonic acids of the condensates of naphthalene and formalin, and a salt thereof represented by formula (18) include, for example, ammonium salt of a condensate of naphthalene sulfonic acid and formalin.

The example of alkyl phenyl ether sulfonic acids and a salt thereof represented by formula (19) include, for example, lignin sulfonic acid ammonium.

The ampholytic surfactant includes a betaine-type amphoteric surfactant such as coconut oil fatty amide propyldimethylaminoacetic acid betaine, lauryldimethylaminoacetic acid betaine, 2-alkyl-N-carboxymethyl-N-hydroxyethylimidazolinium betaine, and laurylhydroxysulfobetaine and an amino acid-type amphoteric surface-active agent such as β-laurylamino sodium propionate. In addition to these, a dispersing agent such as polymer dispersing agent can be used.

Among the above-mentioned surfactants, an anionic surfactant is preferable from the viewpoint of controlling the etching rate of metal wiring, more preferably an anionic surfactant having a carboxylic acid group. Furthermore, among the surfactants, a surfactant having an oxyethylene and/or an oxypropylene is in particular preferable from the viewpoint of water-solubility, and an oxyethylene is most preferable from the viewpoint of its availability.

A surfactant used in a metal abrasive composition of the present invention preferably has a concentration of 0.0001 to 5 weight %, more preferably 0.005 to 3 weight %, and in particular preferably 0.01 to 1 weight %. When a concentration of a surfactant is less than 0.0001 weight %, the etching rate of metal wiring may not be controlled, while the concentration is more than 5 weight %, the foaming may not be suppressed.

In order not to cause a scratch or the dishing, depending on the kind of wiring to be polished, a corrosion inhibitor may be further added to a metal abrasive composition of the present invention.

A conventional corrosion inhibitor can be used benzotriazole and a benzotriazole derivative are preferably used. The example of a benzotriazole derivative include, for example, o-tolyltriazole, m-tolyltriazole, p-tolyltriazole, carboxybenzotriazole, nitrobenzotriazole, 1-hydroxypropylbenzotriazole, 2,3-dicarboxypropylbenzotriazole, 4-hydroxybenzotriazole, 4-methoxycarbonyl-1H-benzotriazole, 4-butoxycarbonyl-1H-benzotriazole, 4-octyloxycarbonyl-1H-benzotriazole and 5-hexyl benzotriazole. Among these, o-tolyltriazole, m-tolyltriazole, p-tolyltriazole and 4-hydroxybenzotriazole are preferable.

The concentration of the corrosion inhibitor is preferably in a range of approximately 0.01 to 0.2 weight %.

The additional mixing of an oxidizer into a metal abrasive composition of the present invention enables the polishing rate to be further improved.

The oxidizer includes an oxidizer such as hydrogen peroxide, iodic acid and iodate; among these, hydrogen peroxide is preferable.

The content of the oxidizer is typically approximately 0.1 to 15 weight % with respect to the abrasive. When a concentration of the oxidizer is less than 0.1 weight %, the improvement in the polishing rate may not be sufficient, while the concentration is more than 15 weight %, an improvement in the polishing rate proportionate to the concentration may not be recognized.

An additive such as a nonionic surfactant may be added to a metal abrasive composition of the present invention, from the viewpoint of dispersion stability, sedimentation prevention and improvement of polished surface roughness.

The nonionic surfactant includes an aliphatic alcohol with a carbon number of 8 to 24 alkylene oxide with a carbon number of 2 to 8 adduct (the degree of polymerization=1 to 100) such as an ethylene oxide adduct (the degree of polymerization=15) of lauryl alcohol, a polyoxyalkylene with a carbon number of 2 to 8 in the alkylene group (the degree of polymerization=1 to 100) higher fatty acid with a carbon number of 8 to 24 ester such as polyethylene glycol monostearate (the degree of polymerization=20) and polyethylene glycol distearate (the degree of polymerization=30), a polyhydric (dihydric to decahydric or more) alcohol fatty ester with a carbon number of 8 to 24 in the ester such as glyceryl monostearate, ethylene glycol monostearate and sorbitan monolaurate, a (poly)oxyalkylene with a carbon number of 2 to 8 in the alkylene group (the degree of polymerization=1 to 100) polyhydric (dihydric to decahydric or more) alcohol higher fatty ester with a carbon number of 8 to 24 in the ester such as polyoxyethylene (the degree of polymerization=10) sorbitan monolaurate and polyoxyethylene (the degree of polymerization=50) methyl glucoside dioleate], a fatty acid with a carbon number of 8 to 24 alkanolamide such as monoethanolamide oleate, a (poly)oxyalkylene with a carbon number of 2 to 8 in the alkylene group (the degree of polymerization=1 to 100) alkyl with a carbon number of 8 to 24 amino ether and an alkyl with a carbon number of 8 to 24 dialkyl with a carbon number of 1 to 6 amine oxide such as lauryl dimethylamine oxide, trioleyl phosphate, tri(poly)oxyethylene lauryl ether phosphoric acid, tri(poly)oxyethyleneoxypropylene lauryl ether phosphoric acid, tri(poly)oxyethylene cetyl ether phosphoric acid, tri(poly)oxyethyleneoxypropylene cetyl ether phosphoric acid, and tri(poly)oxypropylene cetyl ether phosphoric acid and the like.

A metal abrasive composition of the present invention is typically dispersed into water so as to be used as slurry, and then pH thereof is preferably 3 to 10, more preferably 4 to 9.

A pH controlling agent may be added to the metal abrasive composition, and acid or alkali can be used as the pH controlling agent; preferably using acid or alkali not including a metal ion, such as nitric acid, phosphoric acid, sulfuric acid, ammonium hydroxide and amine.

The mixing order of each component is not particularly limited in a metal abrasive composition of the present invention. In the case where a metal abrasive composition of the present invention is dispersed into water so as to be made into slurry, a method can be applied thereto; for example, a method of dispersing by a homogenizer, a supersonic wave, a wet medium mill and the like.

Also, in the case of mixing an oxidizer, all components

A method of manufacturing semiconductor device having metal wiring will be described as follows.

An insulation layer with an active region is formed on a semiconductor substrate. A photo-resist pattern is formed on the insulation layer. Thereafter, etcing, such as dry etching, of the insulation layer is carried out using the photo-resist pattern as a mask thereby to form a contact hole in the insulation layer so that the contact hole is positioned over the active region of the semiconductor substrate. A part of the active region of the semiconductor substrate is thus shown through the contact hole. Thereafter, the used photo-resist pattern is removed from the surface of the insulation layer.

A barrier layer made of a metal such as Ti or Ta is formed covering the top surface of the insulation layer as well as on side walls and a bottom of the contact hole so that the barrier layer is in contact with part of the active region of the semiconductor substrate.

A conductive material such as Al or Cu is deposited covering the barrier layer so that the contact hole is completely filled with the conductive material and the conductive material extends over the barrier layer on the top surface of the conductive material.

A chemical mechanical polishing method is carried out to polish the surface of the conductive material so that the conductive material extending over the insulation layer is removed whereby the conductive material remains only within the contact hole.

A metal abrasive composition of the present invention is appropriately used for polishing metal wiring in manufacturing a semiconductor device as mentioned above.

The metal of metal wiring to be polished includes native copper, copper alloy, pure aluminum (Al), alloy consisting essentially of aluminum such as aluminum-silica-copper (AlSiCu) alloy and aluminum-copper (AlCu) alloy, tungsten, titanium, titanium nitride, tantalum, tantalum nitride, and the like; preferably including native copper, copper alloy and the like.

In the case of being polished by using a metal abrasive composition of the present invention, metal wiring is polished by a chemical mechanical polishing, and then the polishing by using a metal abrasive composition of the present invention enables metal wiring to be polished at high speed, a scratch to be controlled against occurrence on a polished surface, and the etching rate of metal wiring to be controlled.

### EXAMPLES

The present invention is hereinafter described by examples, and it is apparent that the present invention is not limited thereto.

The average particle diameter of a particle in a metal abrasive composition was defined as a diameter of which a cumulative amount is 50% of tatal amount measured by a microtrac UPA particle size analyzer (trade name: manufactured by NIKKISO CO., LTD.).

Also, the polishing rate was measured by polishing a wafer, which is provided with a copper membrane formed by sputtering, on the following conditions.

[Polishing Conditions]

Polisher: MECAPOLE-460 (manufactured by PRESI CO., LTD.)

Pad: polyurethane type

The number of rotations in a rotary surface plate: 60 rpm

The number of rotations in a wafer-retaining desk: 60 rpm

Polishing pressure: 250 g/cm²

Abrasive flux: 100 ml/minute

Polishing time: 30 seconds

The presence of occurrence of a scratch was confirmed by visual observation and optical microscope observation on a wafer surface after being polished.

The etching rate was calculated in such a manner that a wafer provided with a copper membrane formed by plating was immersed in a metal abrasive composition at a temperature of 25° C. for 5 minutes so as to convert the weight change of a wafer before and after the immersion.

### Production Example 1

### Preparation of Chelating Resin Particle Slurry

1 L of a chelating resin particle (manufactured by SUMITOMO CHEMICAL CO., LTD., counteranion: Na type, trade name: “SUMICHELATE MC-700”) having an iminodiacetic acid group as a functional group was filled into a column to be washed with ultrapure water, and thereafter 10 L of 2 N-hydrochloric acid solution was flown therethrough so as to be washed with ultrapure water again and thereby made into an H type chelating resin particle. 10 L of 2 N ammonia water was further flown therethrough so as to be washed with ultrapure water again and dehydrated, thereby obtaining an ammonium type chelating resin particle. 27.5 kg of the ammonium type chelating resin particle obtained through the same treatment was treated by dry grinding by with an impeller mill (trade name: manufactured by SEISHIN ENTERPRISE CO., LTD.). 23.3 kg of a ground product was obtained on the grinding conditions that the number of rotations in a rotor was 6000 rpm and the supplied quantity was 15 kg/hr. The average particle diameter of the ground product was 43 μm.

12.9 kg of ultrapure water was added to 7.1 kg of the obtained ground product so as to obtain a dispersion solution by stirring, and then this dispersion solution was wet-grinding by an ultimaizer (trade name: manufactured by SUGINOMACHINE LIMITED). The grinding conditions were a treatment pressure of 245 MPa, the supplied quantity of 2.5 L/minute and 25 passes. The average particle diameter of the obtained chelating resin particle was 0.32 μm.

### Example 1

### Preparation of a Metal Abrasive Composition

10 weight % of resin particle slurry obtained in Production Example 1, 0.5 weight % of colloidal silica A (manufactured by NIPPON CHEMICAL INDUSTRIAL CO., LTD., average particle diameter: 10 to 20 μm, trade name: “SILICADOL20A”) as an inorganic particle, 0.3 weight % of polyoxyethylene sodium lauryl ether acetate (the degree of polymerization=3) (manufactured by LION CORPORATION, trade name: “ENAGICOL EC-30”) as a surfactant, 0.01 weight % of benzotriazole as a corrosion inhibitor, and 1.5 weight % of hydrogen peroxide as a oxidizer were prepared and thereafter made into pH4 by using nitric acid, thereby obtaining a metal abrasive composition. The results are shown in Table 1.

### Example 2

### Preparation of a Metal Abrasive Composition

A metal abrasive composition was obtained in the same manner as Example 1 except for replacing the inorganic particle with colloidal silica B (manufactured by NISSAN CHEMICAL INDUSTRIES, LTD., average particle diameter: 40 to 50 μm, trade name: “SNOWTEX-OL”). The results are shown in Table 1.

### Example 3

### Preparation of a Metal Abrasive Composition

A metal abrasive composition was obtained in the same manner as Example 1 except for replacing the inorganic particle with colloidal silica C (manufactured by NISSAN CHEMICAL INDUSTRIES, LTD., average particle diameter: 70 to 100 μm, trade name: “SNOWTEX-ZL”). The results are shown in Table 1.

### Example 4

### Preparation of a Metal Abrasive Composition

A metal abrasive composition was obtained in the same manner as Example 1 except for replacing the surfactant with polyoxyethylene alkyl sulfosuccinate disodium (carbon number: 12 to 14, the degree of polymerization=4) (manufactured by TOHO CHEMICAL INDUSTRY CO., LTD., trade name: “KOHAKULL-400A”). The results are shown in Table 1.

### Example 5

### Preparation of a Metal Abrasive Composition

A metal abrasive composition was obtained in the same manner as Example 1 except for replacing the surfactant with polyoxyethylene tristyrylphenyl ether phosphate amine (manufactured by TAKEMOTO OIL & FAT CO., LTD., trade name: “NEWKALGEN FS-3”). The results are shown in Table 1.

### Example 6

### Preparation of a Metal Abrasive Composition

A metal abrasive composition was obtained in the same manner as Example 1 except for replacing the surfactant with polyoxyethylene lauryl ether acetic acid (polymerization degree: 4.5, manufactured by Lion Corporation., trade name: “ENAGICOL EC-A”). The results are shown in Table 1.

### Example 7

### Preparation of a Metal Abrasive Composition

A metal abrasive composition was obtained in the same manner as Example 1 except for replacing the surfactant with polyoxyethyleneoxypropylene tristyrylphenyl ether ammonium sulfate (manufactured by TAKEMOTO OIL & FAT CO., LTD., trade name: “NEWKALGEN FS-7”). The results are shown in Table 1.

### Comparative Example 1

### Preparation of a Metal Abrasive Composition

A metal abrasive composition was obtained in the same manner as Example 1 except for replacing the surfactant with lauryl dimethylbenzilammonium chloride (manufactured by TOHO CHEMICAL INDUSTRY CO., LTD., trade name: “CATINAL CB-30”). The results are shown in Table 1.

### Comparative Example 2

### Preparation of a Metal Abrasive Composition

A metal abrasive composition was obtained in the same manner as Example 1 except for replacing the chelating resin particle with a resin particle (manufactured by MITSUI CHEMICALS, INC., trade name: “GLOSSDELL ASE69”) having a carboxylic acid as a functional group. The results are shown in Table 1.

### Comparative Example 3

### Preparation of a Metal Abrasive Composition

10 weight % of resin particle slurry obtained in Production Example 1, 0.5 weight % of colloidal silica A as an inorganic particle, 0.01 weight % of benzotriazole as a corrosion inhibitor, and 1.5 weight % of hydrogen peroxide as a oxidizer were prepared and thereafter made into pH4 by using nitric acid, thereby obtaining a metal abrasive composition. The results are shown in Table 1.

TABLE 1

| | Polishing Rate | Etching Rate |
|---|---|---|
| | (Å/min) | (Å/min) |
| Example 1 | 4590 | 9 |
| Example 2 | 3691 | 39 |
| Example 3 | 3824 | 30 |
| Example 4 | 5837 | 23 |
| Example 5 | 7208 | 49 |
| Example 6 | 4250 | 9 |
| Example 7 | 3237 | 100 |
| Comparative Example 1 | 1205 | 255 |
| Comparative Example 2 | 36 | 14 |
| Comparative Example 3 | 3576 | 165 |

The following are understood by the results in Table 1. With regard to a metal abrasive composition comprising a mixture of a chelating resin particle, an inorganic particle, and a surface-active agent having at least one kind of functional group selected from the group consisting of a carboxylic group, a sulfonic group and a phosphoric group, the polishing by the metal abrasive composition enabled metal to be polished at high speed and the etching rate to be controlled. Also, no scratch was observed on a surface thereof after being polished. On the other hand, with regard to a metal abrasive composition employing a surfactant having a functional group except a carboxylic acid group, a sulfonic acid group and a phosphoric acid group, the polishing by the metal abrasive composition did not enable a sufficient polishing rate to be obtained, and the etching rate to be controlled. Also, with regard to a metal abrasive composition employing a resin particle having a carboxylic acid as a functional group, the polishing by the metal abrasive composition did not enable a sufficient polishing rate to be obtained.

In addition, with regard to a metal abrasive composition comprising a chelating resin particle and an inorganic particle, the polishing by the metal abrasive composition did not enable the etching rate to be controlled.

In accordance with the present invention, metal wiring can be polished at high speed and the etching rate of metal wiring can be controlled and additionally the occurrence of a scratch can be controlled on a polished surface, whereby a particularly excellently processed surface can be obtained.

What is claimed is:

1. A metal abrasive composition comprising:
(a) a chelating resin particle having at least one functional group selected from the group consisting of an aminocarboxylic acid group, an aminophosphonic acid group and an iminodiacetic acid group;
(b) an inorganic particle; and
(c) a surfactant having at least one functional group selected from the group consisting of a carboxylic acid group, a sulfonic acid group and a phosphoric acid group.

2. A metal abrasive composition according to claim 1, wherein (a) the chelating resin particle is a chelating resin particle having an average particle diameter of 1.0 μm or less.

3. A metal abrasive composition according to of claim 1, wherein (b) the inorganic particle is colloidal silica.

4. A metal abrasive composition according to any one of claims 1 to 3, wherein
an average particle diameter of (a) the chelating resin particle is denoted as A and an average particle diameter of (b) the inorganic particle is denoted as B, a ratio (A/B) is 3 or more.

5. A metal abrasive composition according to claim 1, wherein (c) the surfactant is an anionic surfactant.

6. A metal abrasive composition according to claim 5, wherein (c) the surfactant is a surfactant having at least one of an oxyethylene and an oxypropylene.

7. A metal abrasive composition according to claim 1, wherein the composition further comprises at least one selected from the group consisting of benzotriazole and benzotriazole derivatives.

8. A metal abrasive composition according to claim 1, wherein the composition further comprises an oxidizer.

9. A metal abrasive composition according to claim 8, wherein the oxidizer is hydrogen peroxide.

10. A metal abrasive composition according to claim 1, wherein the metal abrasive composition is a copper-based metal abrasive composition.

11. A method of polishing metal comprising the step of polishing by a chemical mechanical polishing with a metal abrasive composition according to any one of claims 1 to 10.

12. A process for producing a semiconductor device comprising polishing a substrate for the semiconductor device having metal wiring by a chemical mechanical polishing with a metal abrasive composition according to any one of claims 1 to 10.

13. The process according to claim 12, wherein the metal contains cupper.
